(19) United States
(12) Patent Application Publication
(10) Pub. No.: US 2011/0227746 A1
(43) Pub. Date: Sep. 22, 2011

(54) DOOR CONTROL APPARATUS

(75) Inventors: Blue Houser, Edgemoor, SC (US); Tommy McNally, Indian Trail, NC (US); Michael Allen Webb, Cave Creek, AZ (US); Max Stephen Smith, Milan, TN (US); Asa Christiander, Nacka (SE)

(73) Assignee: YALE SECURITY INC., Monroe, NC (US)

(21) Appl. No.: 12/725,884

(22) Filed: Mar. 17, 2010

(51) Int. Cl. G08B 21/18; F16M 13/02; E05F 15/12; E06B 3/00; E05F 1/10; H04R 25/00

(52) U.S. Cl. 340/686.1; 248/220.21; 49/358; 49/506; 16/72; 381/150

(57) ABSTRACT

A door control apparatus and methods for controlling a door motion device for a hinged door and, optionally, illuminating a designated area on the floor. During the time the designated area is illuminated, a person can expect that the door will not close. The door control apparatus may include control circuitry, and a sensor, and optionally a light emitter and/or a sound emitter. The sensor detects a person proximate to the door and signals the control circuitry upon a detection event. The light emitter is also connected to the control circuitry. Upon a detection event, the control circuitry signals the light emitter to produce light and signals the door motion device to hold the door open. The light emitter directs light to form an image on the floor in the designated area. The light emitter may be, for example, a laser generator or a light emitting diode lamp.

### BACKGROUND

Electromechanical door holders and automatic door operators are two types of devices that provide automatic functions with respect to doors. Electromechanical door holders generally include a door closer and apparatus that arrests the operation of the door closer. Electromechanical door holders may be attached to the structure adjacent to a door, such as a door frame or wall, and a pivotable arm extends from the door operator to the door, or alternatively, the electromechanical door holder may be mounted to the door, and the pivotable arm may extend to the adjacent structure. The door closer is intended to provide a smooth, controlled closing action to the door after the door has been opened and released.

Many conventional door closers are mechanically actuated and have a piston and a plurality of springs and valved ports. The piston moves through a reservoir filled with a hydraulic fluid, such as oil. The piston is coupled to the door closer's arm through a rack and pinion such that, as the door is opened, the piston is moved in one direction and, as the door is closed, the piston is moved in the opposite direction. As the piston moves, it displaces hydraulic fluid, which may be forced through various ports. The force exerted by the door closer depends on loading of a compression spring and the speed of the action depends on the open or closed status of the ports. The ports are adjustable (open or closed) via needle valves that control flow of hydraulic fluid between chambers, and the compression spring setting may or may not be adjustable based on the construction of the door closer. The valves may be operated with solenoids connected to a power supply. Energizing a solenoid may close a valve, prevent flow of hydraulic fluid, and thereby provide a hold-open feature to the door closer, making an electromechanical door holder.

With respect to door operators, the purpose of a door operator is to open and close a door. In general, a door operator may be mounted similarly to an electromechanical door holder. Automatic, hinged doors with door operators generally include motorized door openers and door closers that may be powered or spring assisted. The door may open manually or automatically upon actuation of a switch often placed on a wall proximate to the door. When automatic operation is initiated, the door commonly proceeds through a sequence that includes starting the motor, the motor driving the door to an open position, the door being held open for a set period, and then the motor turning off or reversing direction to allow the door closer to close the door.

A variety of automatic door operators is known. A typical door operator includes an electric motor and a linkage assembly for operatively coupling the drive shaft of the motor to a door so that the door will be opened and closed when the drive shaft rotates. Activation of the door operator is initiated by means of an electric signal generated in a variety of ways such as, for example, a pressure switch, an ultrasonic or photoelectric presence sensor, motion sensors, radio transmitters, wall switches, and the like. The door may then be closed under power or with a door closer, as used in an electromechanical door holder.

The automatic, predetermined timing of closing of an automatic door with either a door operator or a door holder creates the opportunity for the door to close on a person who or an object that does not or cannot pass through the doorway in sufficient time to avoid the closing door.

### SUMMARY OF THE INVENTION

In accordance with one embodiment described herein, a door control apparatus may be in electrical communication with an electromechanical door holder for operative connection to a hinged door, the hinged door being above a floor and pivotally movable between a closed position and a fully open position. The hinged door may be mounted to a structure surrounding the door in the closed position, with the structure including a door frame and a wall. The door control apparatus includes control circuitry and a sensor. The sensor is adapted to detect a person, object, or both in a first designated area proximate to the door. The sensor is connected to the control circuitry and is operable to signal the control circuitry upon a detection event. Upon a detection event the control circuitry is operable to signal the electromechanical door holder to hold the door open. The door control apparatus may further include a light emitter that is also connected to the control circuitry, which is operable to signal the light emitter to produce light.

The light emitter may further be adapted to direct light to form an image on the floor in a second designated area. When the second designated area is illuminated, the door is not in the process of closing. The control circuitry may also be operable to signal the light emitter to change the light status a first predetermined time after the sensor detects nothing in the first designated area, and may be adapted to signal the electromechanical door holder to initiate door closing after a second predetermined time, with the first and second predetermined times being measured by a timer in the control circuitry. The light emitter may be, for example, a laser generator or a light emitting diode lamp.

In accordance with another embodiment described herein, a door motion controller is provided for applying force to a hinged door, the hinged door being above a floor and pivotally movable between a closed position and a fully open position. The hinged door is mounted to a structure surrounding the door in the closed position, with the structure including a door frame and a wall. The door motion controller includes an electromechanical door holder adapted to operatively connect to the hinged door, and a door control apparatus. The door control apparatus is adapted to be in electrical communication with the electromechanical door holder and includes control circuitry and a sensor. The sensor is adapted to detect a person, object, or both in a first designated area proximate to the door. The sensor is connected to the control circuitry, and is operable to signal the control circuitry upon a detection event. Upon a detection event the control circuitry is operable to signal the electromechanical door holder to hold the door open. The door control apparatus may further include a light emitter that is also connected to the control circuitry, which is operable to signal the light emitter to produce light.

In accordance with another embodiment described herein, a door assembly that may be positioned above a floor proximate to a structure including a door frame and wall is provided. The door assembly includes a hinged door, a door motion device, and door control apparatus. The hinged door is pivotally movable between a closed position and a fully open position, and mounted to the structure surrounding the door in the closed position. The door motion device is adapted to operatively connect to the hinged door. The door control apparatus is adapted to be in electrical communication with the door motion device and includes control circuitry, a sensor, and a light emitter. The sensor is adapted to detect a person, object, or both in a first designated area proximate to the door. The sensor is connected to the control circuitry, and is operable to signal the control circuitry upon a detection event. The light emitter is also connected to the control circuitry. Upon a detection event the control circuitry is operable to signal the light emitter to produce light and is operable to signal the door motion device to hold the door open.

In accordance with another embodiment described herein, a method of operating a hinged door using an electromechanical door holder is provided. The hinged door being may be above a floor and pivotally movable between a closed position and a fully open position, and may be mounted to a structure surrounding the door in the closed position, with the structure including a door frame and a wall. The method may include a sensor detecting a person, object, the door moving to an open position, or a combination thereof in a first designated area, the sensor signaling control circuitry. A timer in the control circuitry is started, and the control circuitry signals the electromechanical door holder and the electromechanical door holder maintains the door in an open position. The sensor may continue to detect a person or object in the first designated area and signaling the control circuitry to keep the door open, and when the sensor detects nothing in the first designated area, signaling the control circuitry may be ceased. The control circuitry may signal a light emitter to produce light. The light emitter may direct light to form an image on a second designated area on the floor. The control circuitry may signal the light emitter to flash the light for a set period. If the sensor again detects a person or object in the first designated area, the sensor may signal the control circuitry, and the control circuitry may signal the electromechanical door holder to keep the door open and signaling the light emitter to produce constant light. If the sensor detects nothing in the first designated area by the end of the set period, the control circuitry may signal the light emitter to turn off the light and signal the electromechanical door holder to initiate closing of the door.

### BRIEF DESCRIPTION OF THE DRAWINGS

For a more complete understanding of embodiments of a door control apparatus and associated methods, reference should now be had to the embodiments shown in the accompanying drawings and described below. In the drawings:

FIGS. 1 and 2 are perspective views of two embodiments of installed door control apparatus.

FIG. 3 is an elevation view of an embodiment of a door control apparatus as shown in FIG. 2.

FIG. 4 is a bottom plan view of the embodiment of the door control apparatus as shown in FIG. 3.

FIGS. 5-11 are plan views of various embodiments of configurations of installed door control apparatus.

FIGS. 12A-12B are a flow chart of the operation of a door control apparatus embodiment used in conjunction with an electromechanical door holder.

FIGS. 13A-13D are a flow chart of the operation of a door control apparatus embodiment used in conjunction with an automatic door operator including a door closer.

FIGS. 14A-14D is a flow chart of the operation of a door control apparatus embodiment used in conjunction with an automatic door operator with motor-driven open and close functions.

### DETAILED DESCRIPTION

Certain terminology is used herein for convenience only and is not to be taken as a limitation on the embodiments described. For example, words such as “top”, “bottom”, “upper,” “lower,” “left,” “right,” “horizontal,” “vertical,” “upward,” and “downward” merely describe the configuration shown in the figures. Indeed, the referenced components may be oriented in any direction and the terminology, therefore, should be understood as encompassing such variations unless specified otherwise.

As used herein, the term “open position” for a door means a door position other than a closed position, including any position between the closed position and a predetermined fully open position as limited only by structure around the door frame, which can be up to 180° from the closed position.

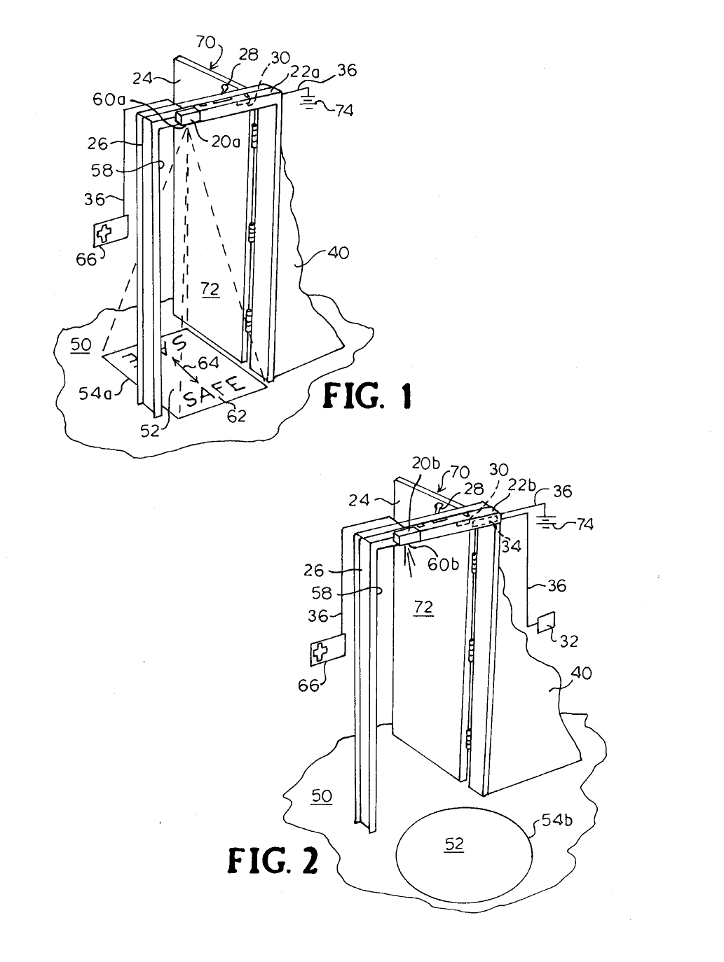

Referring now to the drawings, wherein like reference numerals designate corresponding or similar elements throughout the several views, two embodiments of a door control apparatus are shown in FIGS. 1 and 2 respectively, and are generally designated at 20a and 20b. The door control apparatus 20a, 20b is mounted adjacent to door motion device 22a, 22b, and both are mounted adjacent to a door 24 in a door frame 26 for movement of the door 24 relative to the frame 26 between a closed position and an open position. The door motion device 22a, 22b is operatively connected to the door 24 with an arm operator arm assembly 28. The door motion device may be an electromechanical door holder 22a with a door closer including at least one spring, valve, and solenoid 30 as shown in FIG. 1, or an automatic door operator 22b, connected to an opening switch 32 and a motor 34 with wiring 36, and optionally with a door closer including at least one spring, valve, and solenoid 30. The door 24 may be of a conventional type and is pivotally mounted to the frame 26 for movement from the closed position, as shown in FIG. 1, to an open position for opening and closing an opening through a building wall 40 to allow a user to travel from one side of the wall 40 to the other side of the wall 40. The wall 40 may be of any material, for example, drywall, paneling, brick, block, glass (block or window), and so forth.

In both embodiments of door control apparatus 20a, 20b, a light in the visible spectrum may be projected onto the ground or floor 50 that may indicate an illuminated area 52 that communicates that the door 24 is not about to close. The illuminated area 52 may correspond to a “safe zone” in which a person or object may be located to prevent the door from closing when the person or object is detected by a sensor in the door control apparatus 20a, 20b. Alternatively, the position of the light may not necessarily correspond to the range of the sensor. The visible light may be from various types of light emitters, for example, laser light 54a from a laser generator 60a as in the door control apparatus 20a of FIG. 1, or light emitting diode (LED) light 54b from an LED lamp 60b as in the door control apparatus 20b of FIG. 2. The sensor will cause the door 24 to be held open when an area near the doorway 58 is occupied, with the range and orientation of the sensor provided as determined by one of ordinary skill in the art. A line of laser light 54a may outline the illuminated area 52 or may take the form of lines, words, or another pattern making an image on the floor, while an LED will light a spot 54b on the floor to indicate the illuminated area 52. While the embodiments of FIGS. 1 and 2 as described reflect the areas detected by the sensor and illuminated by the light emitter as generally corresponding to one another, it is contemplated that the light may be directed to one area while the sensor is set to detect movement in another direction, or a larger, overlapping area.

As shown, the shape of the laser light line 54a on the floor 50 is a rectangle, but the light may be an oval or any possible shape as selected by one of ordinary skill in the art, and may include words 62 or other indicia, such as arrows 64. Green light may be used in one embodiment to signal that the door 24 is not about to close; flashing green or yellow light could signal that the door 24 is going to close. An LED may light a spot 54b of colored light, such as a soft green glow, on the floor 50 to designate the illuminated area 52, shown as an oval in FIG. 2. In addition, a selectively lighted display 66 may be provided on one or both sides of the door 24 to alert people that the door is about to open or that the doorway 58 is indeed safe to enter without an expectation of the door closing. The illuminated area 52 may be lit green, for example, when it is safe to enter the doorway 58, and may flash when the door 24 is about to close. The display 66 may also flash, for example, on the “pull side” 70 of the door, towards which the door will open, when someone from the opposite “push side” 72 is going to open the door, and display 66 may flash in a green or yellow light when the door 24 is about to open. The door motion device 22a, 22b, door control apparatus 20a, 20b, switch 32, and display 66 are connected with wiring 36 to an electrical power source 74.

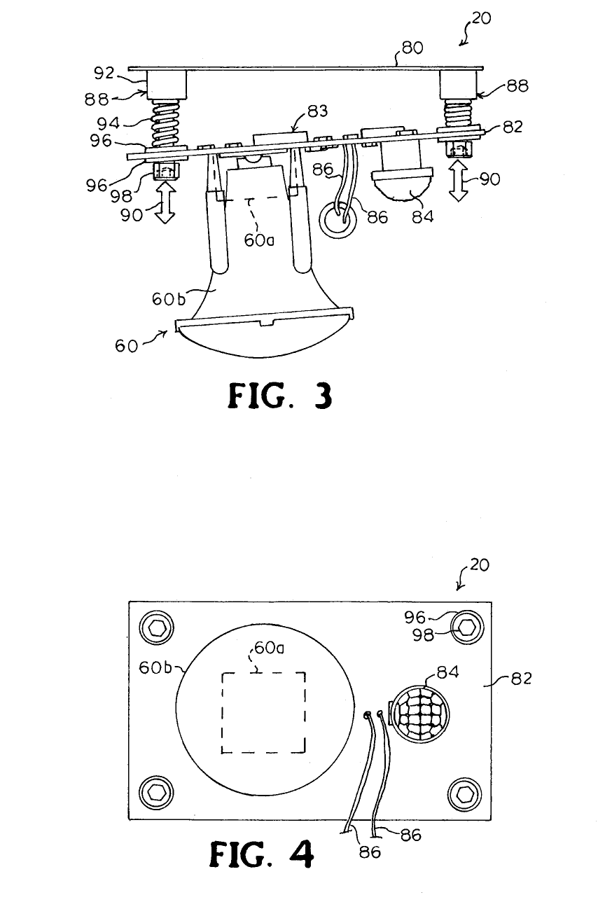

An embodiment of the door control apparatus 20 is shown in FIGS. 3 and 4. The door control apparatus 20 includes a housing 80, which is shown only in part, a mounting board, which in this embodiment includes electronic circuitry and is a printed circuit board (PCB) 82, a light emitter shown as an LED lamp 60b, or alternatively laser generator 60a, a sensor 84, and electrical wiring 86 to connect the PCB 82 to the door motion device 22 and the electrical power source 74. Laser generator 60a is shown schematically, and may also represent any type of light emitter. The light emitter 60 and sensor 84 are mounted and electrically connected to the PCB 82, which may alternatively be any other type of mounting member. Control circuitry 83 may be included on the PCB or otherwise associated with any mounting member. The PCB 82 may be substantially a rectangle shape and is adjustably mounted to the housing 80 with hardware 88 in each corner of the PCB 82 that allows directing of the LED 60b and sensor 84 based on angling of the PCB 82. In the door control apparatus 20a, 20b shown, the angling of the PCB 82 is performed through the vertical movement 90 available at each corner. The door control apparatus 20a, 20b may also be configured to permit angling of the light emitter 60a, 60b and sensor 84 in different directions, for example, on different sides of the doorway 42. Optionally, the light emitter 60a, 60b may be omitted. The light emitter 60a, 60b and sensor 84 may also be mounted separately, such as in different housings on the same or opposite sides of the doorway 58.

The light emitter may be any LED lamp 60b or other type of light emitter that projects a discernable lighted area on the floor as selected by one of ordinary skill in the art, such as a high intensity discharge lamp (spot light) or a laser light 60a. Appropriate light emitters include for LED, Light Engines, from Lighting Sciences Group Corp. of Satellite Beach, Fla., the Atlas I series, 216 lumens, green color, and for lasers, a laser generator as selected by one of ordinary skill in the art. The sensor 84 may be a sensor that detects the presence or motion of a person or object in an area at least as large as, or larger than, the illuminated area 52. Sensors appropriate for use with door control apparatus 20a, 20b include passive infrared type motion sensors such as those made by Panasonic Electric Works Co., Ltd., MP Motion Sensor, and in particular the 10 m detection type, low current consumption, with a detection range of 110 degrees horizontal and 93 degrees vertical. This sensor detects changes in infrared radiation that occur when there is movement by a person or object that has a different temperature than the environment. Another sensor appropriate for use with the door control apparatus 20a, 20b, which may be mounted separately from the housing 80, is a microwave sensor such as that manufactured by BEA Inc. of Pittsburgh, Pa., Eagle Motion Sensor, which operates at 24.125 GHz with a planar antenna with motion detection based on the Doppler effect. Other types of sensors, such as ultrasonic or photoelectric may be selected as known by one of ordinary skill in the art.

As an alternative embodiment, the lamp designated as 60, 60a, or 60b may be instead a sound emitter, such as a speaker, other sound transducer, or producer of sound as known by one of ordinary skill in the art. The sound emitter may be mounted separately from the rest of the apparatus, or may be located as shown. Yet further, the part 60, 60a, or 60b may designate both a light emitter and a sound emitter. The sound emitter may be selectively signaled to alarm when the door is opening, is about to close, or is closing.

The control circuitry 83 uses a constant current source which supplies power needed to the light emitter. Overall product functionality may be controlled by an eight bit microcontroller. User adjustments for delay time, number of warning flashes and, where an LED is used, LED light intensity, may be provided. Cold contact relay switches may be controlled by the microcontroller to switch a solenoid and an external alarm. Control circuitry 83 associated with the PCB 82, other mounting member, or the door control apparatus 20 overall, may further include features such as an embedded processor, memory, a digital signal processor, a motion sensor chip, and a laser control chip, as selected by one of ordinary skill in the art.

The door motion device 22 may be any automatic door operator or electromechanical door holder, such as the 6900 Series Powermatic® automatic door operator or 7200 Series Electromechanical Closer-Holder models from Norton Door Controls of Monroe, N.C., an ASSA ABLOY Group company.

Hardware 88 in each corner to fasten the PCB 82 to the housing 80 and to provide adjustability may include a blind self-cinching fastener 92 such as PEM® brand manufactured by PennEngineering of Danboro, Pa., a spring 94, two washers 96, and a hex socket machine screw 98.

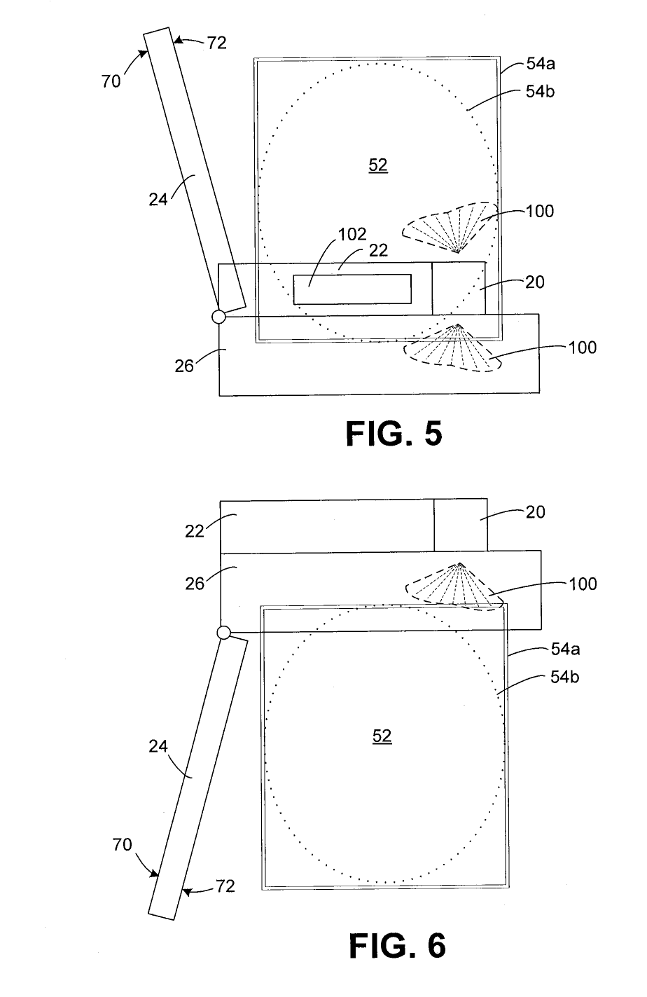

FIGS. 5-11 show various configurations of a door 24, door frame 26, door motion device 22, and door control apparatus 20, which may include a laser generator 60a or an LED lamp 60b or other light emitter (not shown). The rectangle on the floor 50 represents laser light 54a designating the illuminated area 52, while the oval on the floor represents LED light 54b. The illuminated area 52 is lit substantially on the pull side 70 of the door, and detection by the sensor 84 also includes the area on the pull side 70. Two alternative, exemplary, schematic, sensing orientations and ranges 100 are shown in each figure, one of each of which generally corresponds with the illuminated area 52 and the other does not.

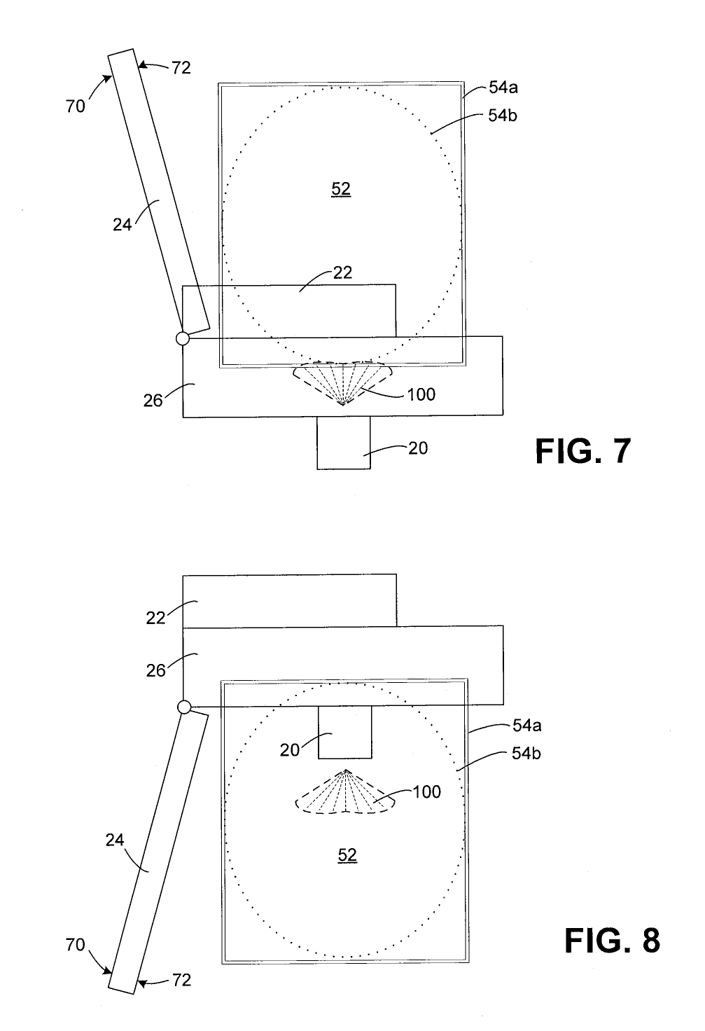

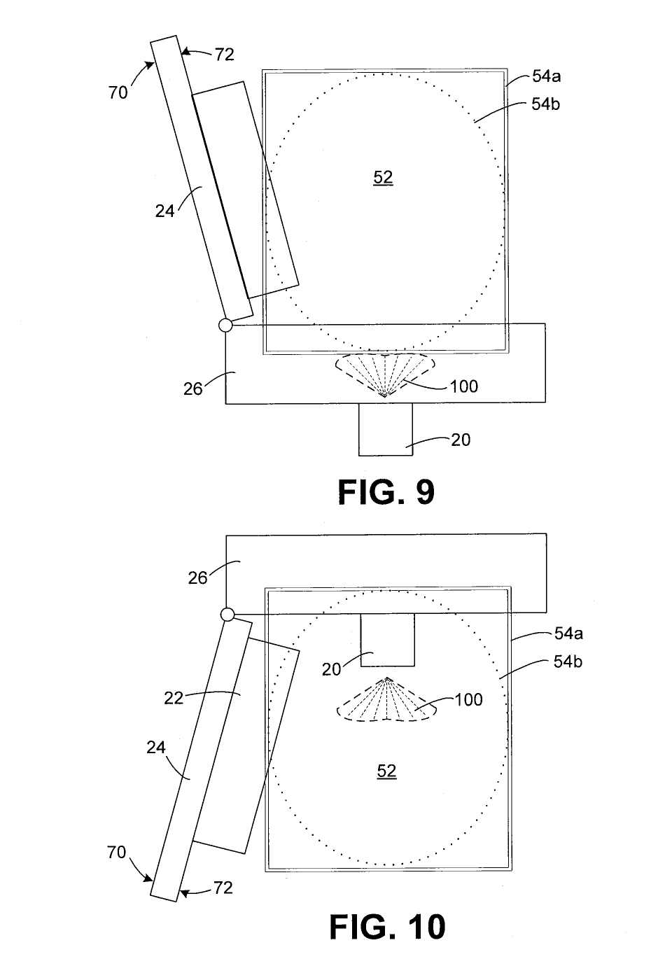

The door motion device 22 in FIGS. 5-10 may be an electromechanical door holder 22a, or an automatic door operator 22b that is not programmed to open the door in response to a signal from the sensor 84. FIG. 5 shows the door motion device 22 including a door closer 102, and the door control apparatus 20 both mounted to the door frame 26 on the pull side 70 of the door 24. FIG. 6 shows the door motion device 22 and the door control apparatus 20 both mounted to the door frame 26 on the push side 72 of the door 24. FIG. 7 shows the door motion device 22 and door control apparatus 20 mounted on opposite sides of the door frame 26, with the door motion device 22 being on the pull side 70 and the door control apparatus 20 being on the push side 72. FIG. 8 again shows the door motion device 22 and door control apparatus 20 mounted on opposite sides of the door frame 26, but with the door motion device 22 being on the push side 72 and the door control apparatus 20 being on the pull side 70. FIGS. 9 and 10 show the door motion device 22 mounted to the pull side 70 of the door 24, with the door control apparatus 20 being mounted to the door frame 26 on the push side 72 in FIG. 9 and to the pull side 70 in FIG. 10.

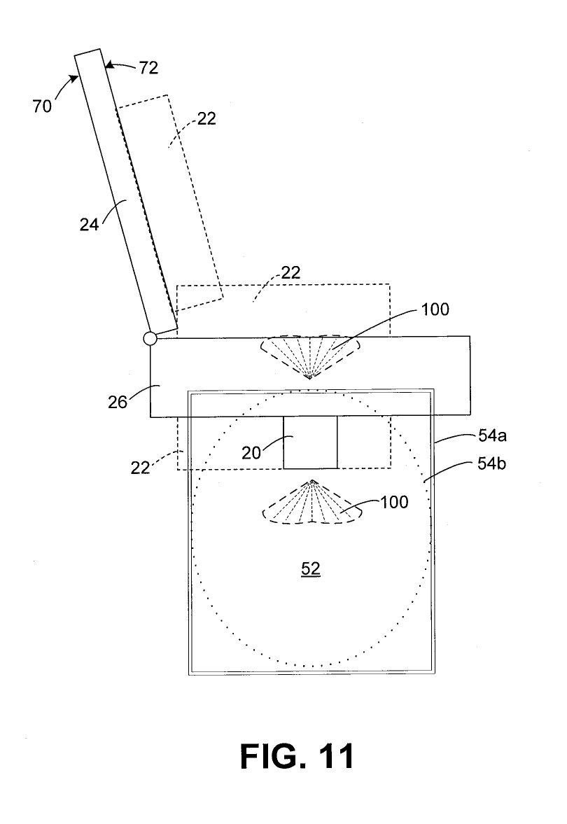

FIG. 11 shows a door motion device 22 that may be of any type, including an automatic door operator 22b that is programmed to open the door in response to a signal from the sensor 84, including either a door closer or a motor 104 with a motor-driven closing function. Three alternate locations for mounting the door motion device 22 are shown. The door control apparatus 20 is mounted on the push side of the door 24 and the sensor 84 may be directed to avoid detecting the motion of the door 24. Where an automatic door operator is programmed to move the door 24 to the fully open position when detecting a person, the closing motion of the door 24 would result in the door 24 being detected, and the door 24 would be opened again when the sensor 84 detects the door 24 closing. Therefore, the sensor 84 may be oriented to detect motion on the push side 72 of the door 24, through which the door 24 does not pass.

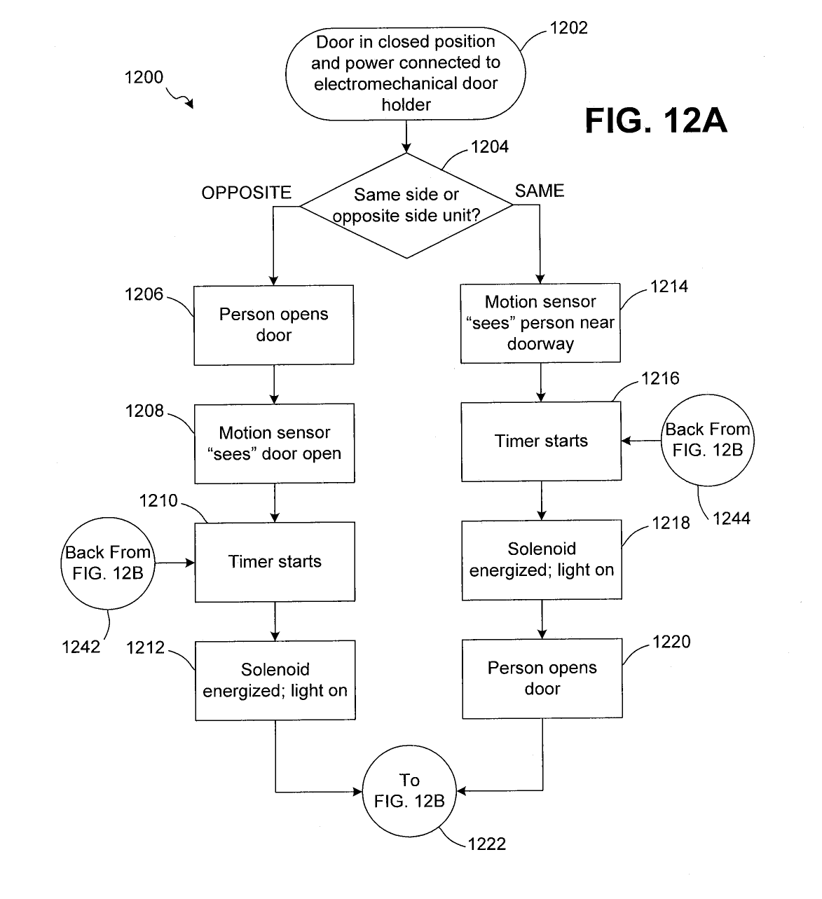

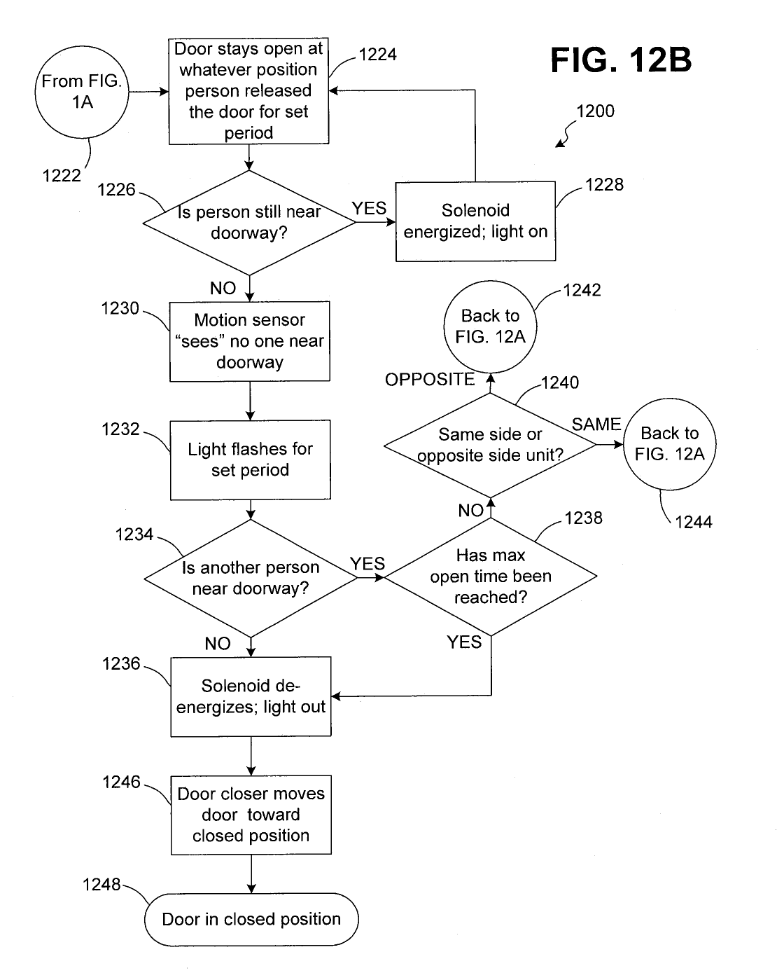

FIGS. 12A-14D show embodiments of the operation of various door control apparatus 20. When a light emitter 60 (and/or sound emitter), solenoid 30, or motor 100 act, they are acting in response to a signal, or the lack of a signal, from the control circuitry 83, which receives signals from the sensor 84. FIGS. 12A and 12B show an embodiment 1200 of the operation of the door control apparatus when used with an electromechanical door holder. Operation begins with the door in the closed position and power connected to the electromechanical door holder 1202. At decision step 1204, the operation is then based on whether the unit, or door control apparatus 20, is mounted on the same side of the door as the person opening the door (a “same side” unit), or on the opposite side of the door from the person opening the door (an “opposite side” unit).

If the door control apparatus 20 is an opposite side unit, the person first opens the door 1206 and the motion sensor detects the opening of the door 1208 and signals the control circuitry. A timer then starts 1210, and a solenoid in the door holder is energized 1212 in response to a signal from the control circuitry to close a valve in the door holder that will prevent flow of hydraulic fluid in the reservoir at a selected port and cause the door to stay open. Optionally and concurrently, when the timer starts, the light emitter is also turned on 1212 in response to a signal from the control circuitry so that the light illuminates the designated floor area; a sound emitter could also alarm when the door is opening.

If the door control apparatus 20 is a same side unit, the motion sensor detects the person near the doorway 1214. A timer then starts 1216, and a solenoid in the door holder is energized 1218 in response to a signal from the sensor via the control circuitry to close a valve in the door holder that will prevent flow of hydraulic fluid in the reservoir at a selected port and cause the door to stay open. When the timer starts, optionally and concurrently the light emitter is also turned on in response to a signal from the sensor via the control circuitry so that the light illuminates the designated floor area 1218. Then the person opens the door 1220.

With the timer started, solenoid energized, floor area illuminated, and door open for either the same side unit or opposite side unit, the operation proceeds through transfer circle 1222 to FIG. 12B. The door stays open at whatever position the person releases the door 1224 for a predetermined set period. If the person is still near the doorway at decision step 1226, the sensor senses the person, and the solenoid continues to be energized and the light stays on 1228, and the process returns to step 1224. If at decision step 1226 the person is not still near the doorway, the motion sensor detects no one near the doorway 1230 and the light flashes for a set period 1232. If there is a sound emitter, the sound emitter may begin to alarm and continue until the door is closed.

If at decision step 1234 another person is not near the doorway, the sensor senses the person, the sensor stops sending a signal to the control circuitry, the solenoid de-energizes to open the valve, and the light is turned off 1236. If another person is near the doorway 1234 and at decision step 1238 the programmed maximum open time has not been reached, the operation returns to the steps where the timer starts 1210, 1218 through decision step 1240 and transfer circles 1242, 1244, as applicable. If the maximum open time has been reached 1238, the light is turned off and then the solenoid de-energizes 1236 to open the valve. From step 1246 the door begins to close, and then has returned to the closed position 1248.

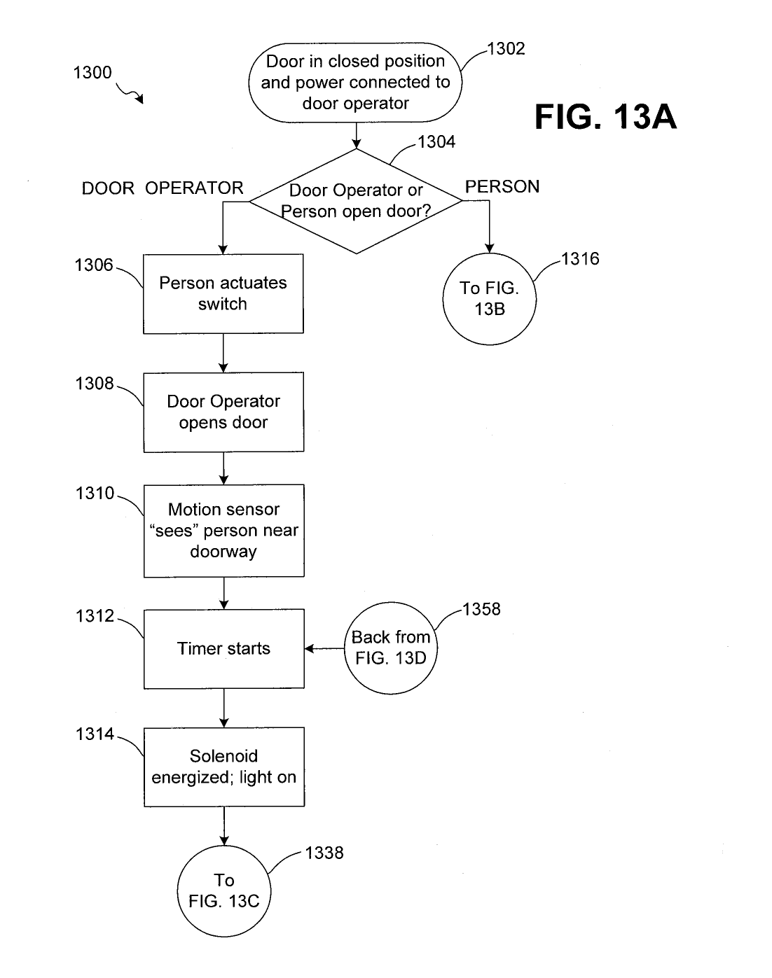

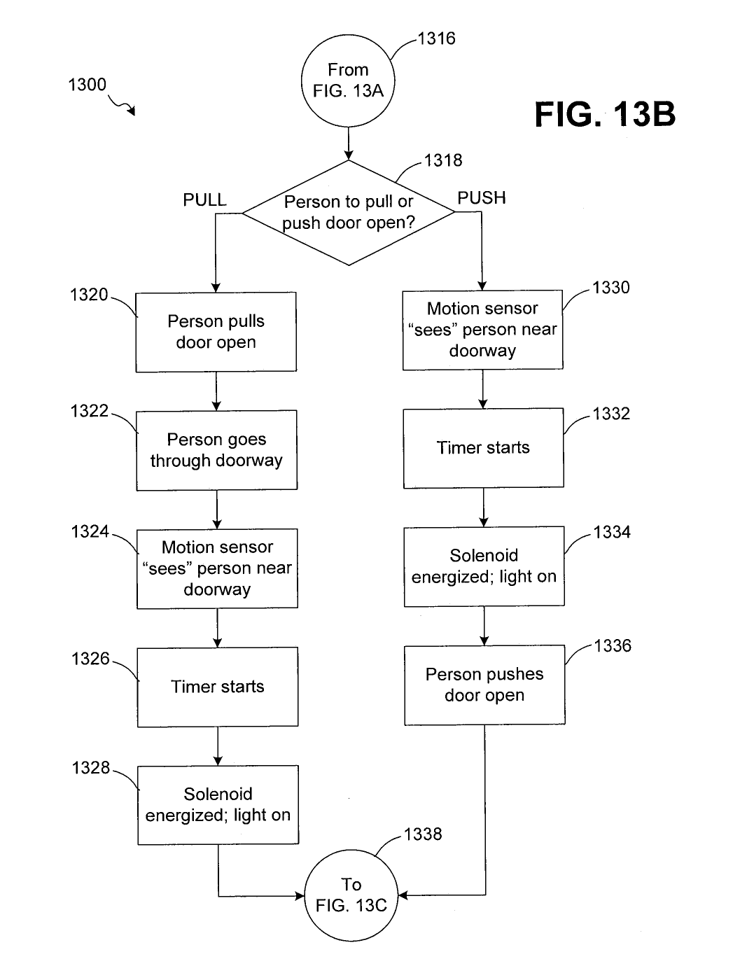

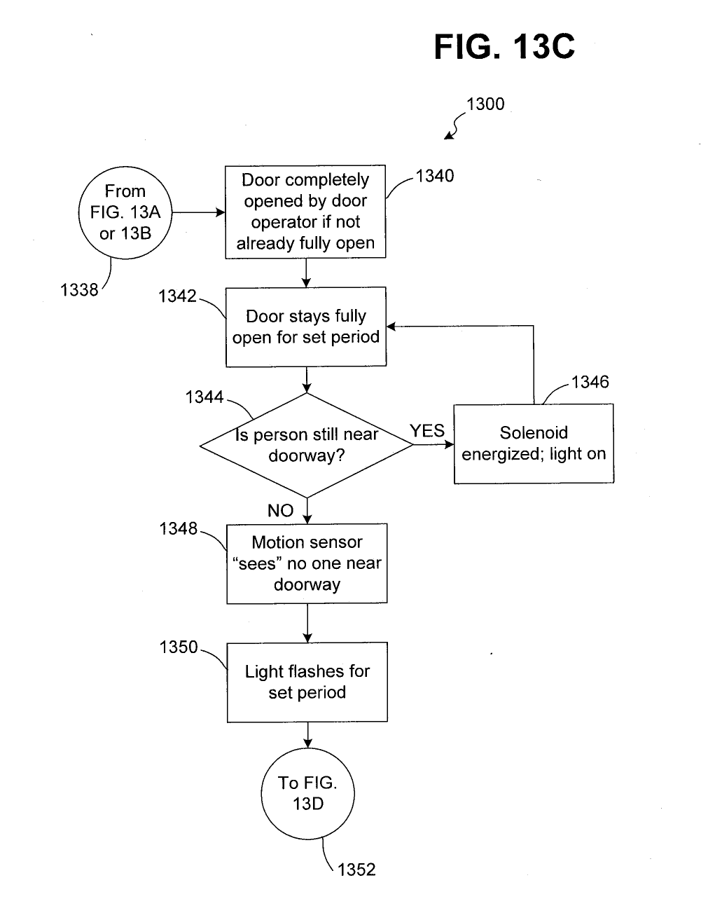

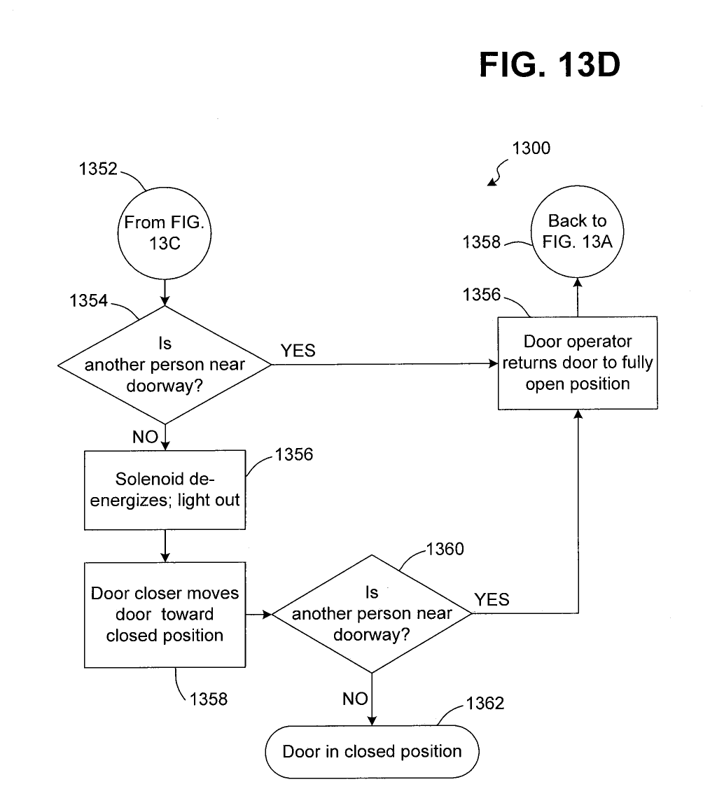

FIGS. 13A-13D show an embodiment 1300 of the operation of the door control apparatus when used with an automatic door operator. Operation begins with the door in the closed position and power connected to the door operator 1302, and continues at decision step 1304 depending on whether the door operator opens the door or a person opens the door. If the door operator opens the door, a person actuates a switch 1306, which may be, for example, a button, a touch pad, a sensor of various types, or other means known to one of ordinary skill in the art. The door operator then opens the door 1308 to the predetermined fully open position. The motion sensor detects a person near the doorway 1310, and a timer starts 1312. Then a solenoid is energized in response to a signal from the sensor via the control circuitry, and optionally a light illuminates the designated floor area 1314 in response to a similar signal; a sound emitter could also alarm on the door opening.

If a person opens the door, the operation proceeds from decision step 1304 through transfer circle 1316 to FIG. 13B. At decision step 1318 the process flow depends on whether the person is to pull or push the door open.

If the person is to pull the door open, the person first opens the door 1320 and then goes through the doorway 1322. The motion sensor detects a person near the doorway 1324. A timer then starts 1326, a solenoid in the door closer is energized in response to a signal from the sensor via the control circuitry, and optionally the light emitter is also turned on similarly so that the light illuminates the designated floor area 1328.

If the person is to push the door open, the motion sensor first detects the person near the doorway 1330. A timer then starts 1332, a solenoid in the door closer is energized in response to a signal from the sensor via the control circuitry, and optionally the light emitter is also turned on so that the light illuminates the designated floor area 1334. A sound emitter could also alarm. Then the person pushes open the door 1336.

With the timer started, solenoid energized, floor area illuminated, and door open, the process proceeds through transfer circle 1338 to FIG. 13C, as does the operation from step 1314 on FIG. 13A. In step 1340, in the embodiment of a door operator currently being discussed, the door is completely opened by the door operator if it is not already fully open. The door stays open for at least a predetermined set period 1342, and at decision step 1344, if a person is still near the doorway and is sensed, the solenoid remains energized and the light stays on 1346 based on a continued signal from the sensor via the control circuitry, resulting in the door continuing to stay open, and the light on, for at least the set period 1342. Once there is not a person near the doorway 1344, the motion sensor detects no one 1348, and if there is a light, the light will flash for a set period 1350. Alternatively, the door operator could be configured to operate like a door holder when the door is pushed manually.

Continuing through transfer circle 1352 to FIG. 13D to decision step 1354, if another person is near the doorway, the door operator engages its motor to return the door to the predetermined fully open position 1356, and the process returns through transfer circle 1358 to restart the timer 1312 on FIG. 13A. If another person is not near the doorway at decision step 1354, the solenoid in the door closer is de-energized in response to the lack of a signal from the sensor via the control circuitry 1356, and the light is likewise turned off. The door operator moves the door towards the closed position 1358. Another decision step 1360 considers whether another person is near the doorway while the door is in the process of closing. If another person is near the doorway, the door operator returns the door to the fully open position 1356, and the operation returns through transfer circle 1358 to step 1312 on FIG. 13A. If no other person has entered the opening, the door continues closing and is returned to the closed position 1362.

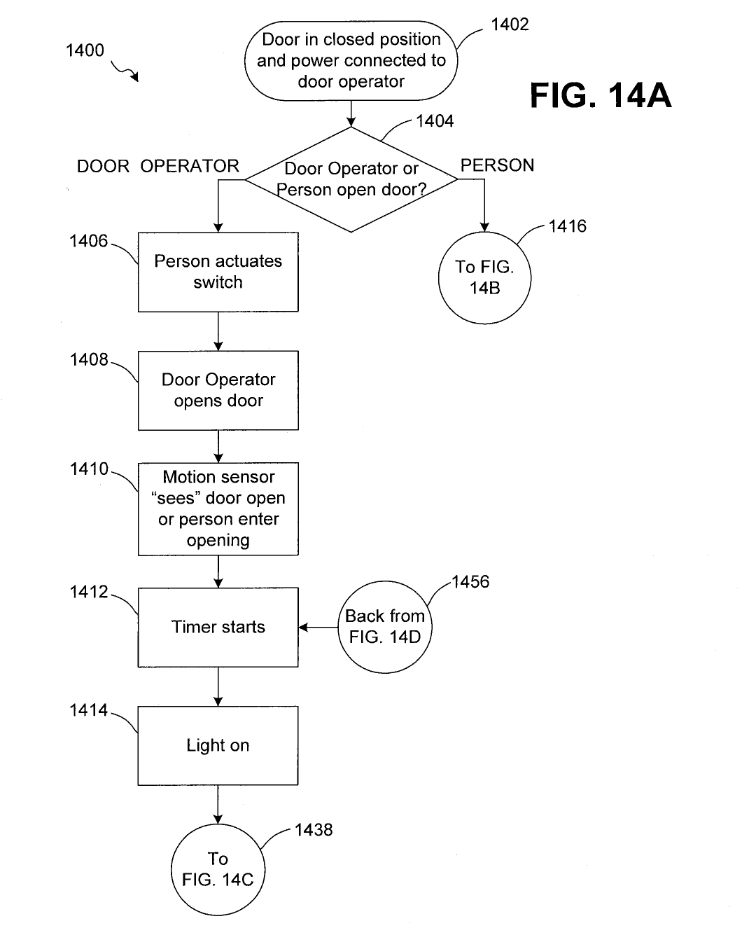

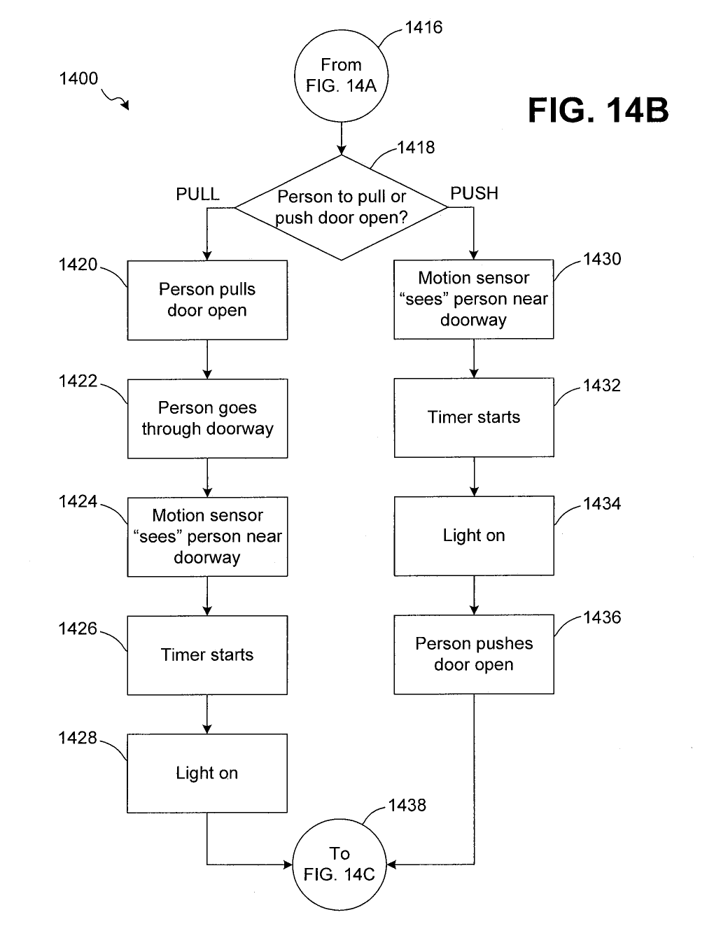

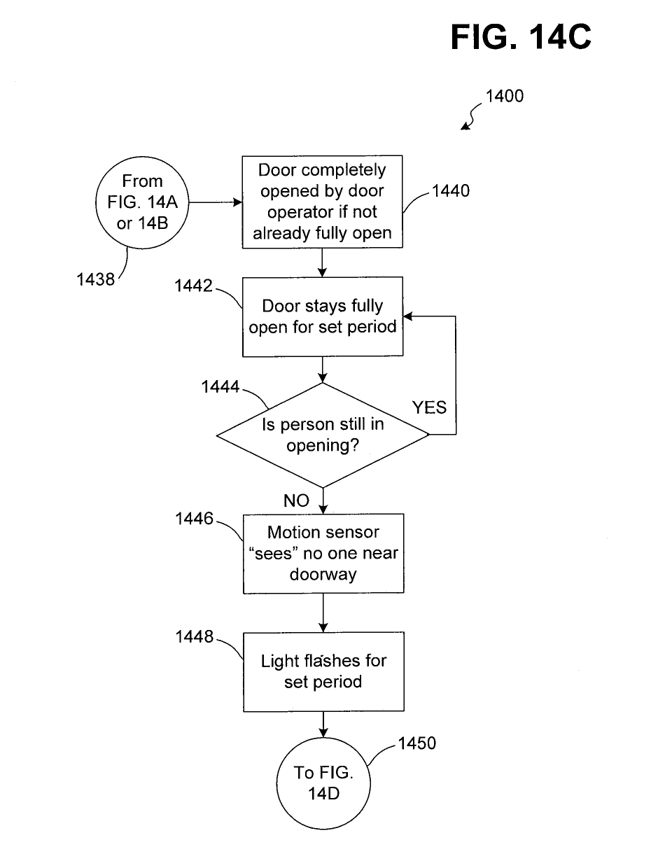

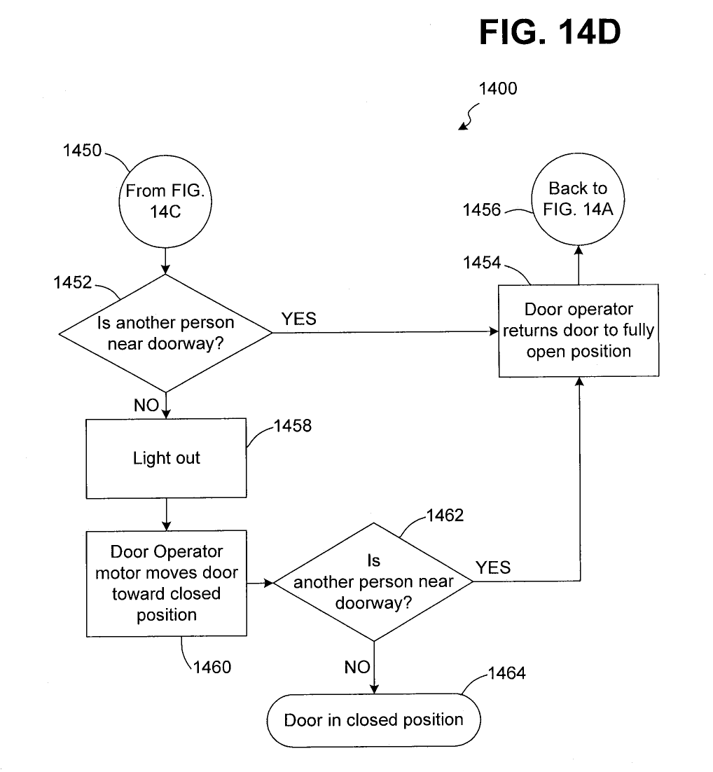

FIGS. 14A-14D show another embodiment 1400 of the operation of the door control apparatus when used with an automatic door operator. Operation begins with the door in the closed position and power connected to the door operator 1402, and continues at decision step 1404 depending on whether the door operator opens the door or a person opens the door. If the door operator opens the door, a person actuates a switch 1406, which may be, as discussed above, a button, a touch pad, a sensor of various types, or other means known to one of ordinary skill in the art. The door operator then opens the door 1408 to a predetermined fully open position. The motion sensor detects a person near the doorway 1410, and a timer starts 1412. Then, optionally, in response to a signal from the sensor via the control circuitry, a light illuminates the designated floor area 1414.

If a person opens the door, the operation proceeds from decision step 1404 through transfer circle 1416 to FIG. 14B. The operation is then based on the decision step 1418 as to whether the person is to pull or push the door open.

If the person is to pull the door open, the person first opens the door 1420 and then goes through the doorway 1422. The motion sensor detects a person near the doorway 1424. A timer then starts 1426, and optionally the light emitter is also turned on so that the light illuminates the designated floor area 1428.

If the person is to push the door open, the motion sensor first detects the person near the doorway 1430. A timer then starts 1432, and optionally the light emitter is also turned on so that the light illuminates the designated floor area 1434. Then the person pushes open the door 1436.

With the timer started, floor area illuminated, and door open, the process proceeds through transfer circle 1438 to FIG. 14C, as does the operation from step 1414 on FIG. 14A. In step 1440, the door is completely opened by the door operator if it is not already in the predetermined fully open position. The door stays open for at least a predetermined set period 1442, and at decision step 1444, if a person is still in the opening, the door continues to stay open for at least the set period 1442. If there is not a person near the doorway, the motion sensor detects no one near the doorway 1446, and if there is a light, the light will flash for a set period 1448. Again, alternatively, the door operator could be configured to operate like a door holder when the door is pushed manually.

Continuing through transfer circle 1450 to FIG. 14D to decision step 1452, if another person is near the doorway, the door operator engages its motor to return the door to the predetermined fully open position 1454, and the process returns through transfer circle 1456 to restart the timer 1412 on FIG. 14A. If another person is not near the doorway at decision step 1452, the light is turned off 1458 in response to the lack of a signal from the sensor via the control circuitry. The door operator engages its motor to move the door toward the closed position 1460. Another decision step 1462 considers whether another person is near the doorway while the door is in the process of closing. If another person is near the doorway, the door operator engages its motor to return the door to the fully open position 1454, and the operation returns through transfer circle 1456 to step 1412 on FIG. 14A. If no other person has entered the opening, the door continues closing and is returned to the closed position 1464.

Although the door control apparatus described above has been shown and described in considerable detail with respect to only a few exemplary embodiments thereof, it should be understood by those skilled in the art that it is not intended to be limited to these embodiments since various modifications, omissions and additions may be made to the disclosed embodiments without materially departing from the novel teachings and advantages. For example, some of the novel features could be used with any type of door motion device or any type of light emitter. A light emitter may be used other than one that shines a light or a floor, or additional light emitters may be used, including but not limited to the selectively lighted display 66. Accordingly, it is intended to cover all such modifications, omission, additions and equivalents as may be included within the scope of a door control apparatus and associated methods as defined by the following claims. In the claims, where a claim is directed to a method, unless otherwise indicated the order of actions to be performed is not limited to the order in which the actions are written. Further, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A door control apparatus in electrical communication with an electromechanical door holder for operative connection to a hinged door, the hinged door being above a floor and pivotally movable between a closed position and a fully open position, and being mounted to a structure surrounding the door in the closed position, the structure including a door frame and a wall, the door control apparatus comprising:
control circuitry; and
a sensor adapted to detect a person, object, or both in a first designated area proximate to the door, the sensor connected to the control circuitry, wherein the sensor is operable to signal the control circuitry upon a detection event,
wherein upon a detection event the control circuitry is operable to signal the electromechanical door holder to hold the door open.

2. The door control apparatus of claim 1, further comprising a light emitter connected to the control circuitry, wherein upon a detection event the control circuitry is operable to signal the light emitter to produce light.

3. The door control apparatus of claim 2, wherein the light emitter is adapted to direct light to form an image on the floor in a second designated area, wherein when the second designated area is illuminated, the door is not in the process of closing.

4. The door control apparatus of claim 3, wherein the control circuitry is operable to signal the light emitter to change the light status a first predetermined time after the sensor detects nothing in the first designated area and is adapted to signal the electromechanical door holder to initiate door closing after a second predetermined time, with the first and second predetermined times being measured by a timer in the control circuitry.

5. The door control apparatus of claim 4, wherein the light status includes on, off, or flashing.

6. The door control apparatus of claim 2, wherein the light emitter includes a laser generator and the light is laser light.

7. The door control apparatus of claim 6, wherein the laser light image to be formed on the floor includes words, other indicia, or a combination thereof.

8. The door control apparatus of claim 2, wherein the light emitter includes a light emitting diode lamp.

9. The door control apparatus of claim 2, further comprising a housing in which the control circuitry, light emitter, and sensor are disposed, wherein the housing is adapted to be mounted to the structure adjacent to the door.

10. The door control apparatus of claim 9, further comprising a mounting member disposed in the housing, wherein the control circuitry, light emitter, and sensor are mounted to the mounting member.

11. The door control apparatus of claim 10, wherein the mounting member comprises a printed circuit board.

12. The door control apparatus of claim 10, wherein the mounting member is mounted to the housing with adjustable fastener components at a plurality of locations that allow varying the angle of the mounting member relative to the housing.

13. The door control apparatus of claim 12, wherein the mounting member is substantially a rectangle and the plurality of locations comprises four locations with each location substantially in a corner of the substantially rectangular mounting member.

14. The door control apparatus of claim 1, further comprising a sound emitter connected to the control circuitry, wherein the control circuitry is selectively operable to signal the sound emitter to produce sound.

15. A door motion controller for applying force to a hinged door, the hinged door being above a floor and pivotally movable between a closed position and a fully open position, and being mounted to a structure surrounding the door in the closed position, the structure including a door frame and a wall, comprising:
an electromechanical door holder adapted to operatively connect to the hinged door; and
a door control apparatus adapted to be in electrical communication with the electromechanical door holder, the door control apparatus comprising:
control circuitry; and
a sensor adapted to detect a person, object, or both in a first designated area proximate to the door, the sensor connected to the control circuitry, wherein the sensor is operable to signal the control circuitry upon a detection event,
wherein upon a detection event the control circuitry is operable to signal the electromechanical door holder to hold the door open.

16. The door control apparatus of claim 15, further comprising a light emitter connected to the control circuitry, wherein upon a detection event the control circuitry is operable to signal the light emitter to produce light.

17. The door motion controller of claim 16, wherein the light emitter is adapted to direct light to form an image on the floor in a second designated area wherein when the second designated area is illuminated, the door is not in the process of closing.

18. The door control apparatus of claim 17, wherein the control circuitry is operable to signal the light emitter to change the light status a first predetermined time after the sensor detects nothing in the first designated area and operable to signal the electromechanical door holder to initiate door closing after a second predetermined time, with the first and second predetermined times being measured by a timer in the control circuitry.

19. The door control apparatus of claim 18, wherein the light status includes on, off, or flashing.

20. The door control apparatus of claim 17, wherein the light emitter includes a laser generator and the light is laser light.

21. The door control apparatus of claim 20, wherein the laser light image to be formed on the floor includes words, other indicia, or a combination thereof.

22. The door control apparatus of claim 17, wherein the light emitter includes a light emitting diode lamp.

23. The door control apparatus of claim 17, further comprising a housing in which the control circuitry, light emitter, and sensor are disposed, wherein the housing is adapted to be mounted to the structure adjacent to the door.

24. The door control apparatus of claim 23, further comprising a mounting member disposed in the housing, wherein the control circuitry, light emitter, and sensor are mounted to the mounting member.

25. The door control apparatus of claim 24, wherein the mounting member comprises a printed circuit board.

26. The door control apparatus of claim 24, wherein the mounting member is mounted to the housing with adjustable fastener components at a plurality of locations that allow varying the angle of the mounting member relative to the housing.

27. The door control apparatus of claim 26, wherein the mounting member is substantially a rectangle and the plurality of locations comprises four locations with each location substantially in a corner of the substantially rectangular mounting member.

28. The door control apparatus of claim 15, further comprising a sound emitter connected to the control circuitry, wherein the control circuitry is selectively operable to signal the sound emitter to produce sound.

29. A door assembly, the assembly being positioned above a floor proximate to a structure including a door frame and wall, comprising:
a hinged door pivotally movable between a closed position and a fully open position, and being mounted to the structure surrounding the door in the closed position;
a door motion device operatively connected to the hinged door; and
a door control apparatus in electrical communication with the door motion device comprising:
control circuitry;
a sensor adapted to detect a person, object, or both in a first designated area proximate to the door, the sensor connected to the control circuitry, wherein the sensor signals the control circuitry upon a detection event; and
a light emitter for directing light to form an image on the floor in a second designated area, wherein when the second designated area is illuminated, the door is not in the process of closing, the light emitter connected to the control circuitry,
wherein upon a detection event the control circuitry signals the light emitter to turn on the light and signals the door motion device to hold the door open.

30. A method of operating a hinged door using an electromechanical door holder, the hinged door being above a floor and pivotally movable between a closed position and a fully open position, and being mounted to a structure surrounding the door in the closed position, the structure including a door frame and a wall, the method comprising:
a sensor detecting a person, object, the door moving to an open position, or a combination thereof in a first designated area, the sensor signaling control circuitry;
a timer in the control circuitry starting;
the control circuitry signaling the electromechanical door holder to hold the door open or to open the door; and
the electromechanical door holder maintaining the door in an open position.

31. The method of claim 30, further comprising the control circuitry signaling a light emitter to produce light and the light emitter directing light to form an image on a second designated area on the floor.

32. The method of claim 31, further comprising:
the sensor continuing to detect a person or object in the first designated area and signaling the control circuitry to keep the door open;
when the sensor detects nothing in the first designated area, ceasing signaling the control circuitry;
the control circuitry signaling the light emitter to flash the light for a set period;
if the sensor again detects a person or object in the first designated area, the sensor signaling the control circuitry, and the control circuitry signaling the electromechanical door holder to keep the door open and signaling the light emitter to produce constant light;
if the sensor detects nothing in the first designated area by the end of the set period, the control circuitry signaling the light emitter to turn off the light and signaling the electromechanical door holder to initiate closing of the door.

33. The method of claim 31, wherein the electromechanical door holder includes a door closer with at least one spring and at least one solenoid, the control circuitry signaling the electromechanical door holder to hold the door open comprises the control circuitry signaling the electromechanical door holder to energize a solenoid to actuate a valve in the electromechanical door holder, and the electromechanical door holder holding the door open comprises the electromechanical door holder holding the door open proximate to the position at which the door was released, and further comprising:
energizing the solenoid after the electromechanical door holder receives a signal from the control circuitry;
the sensor continuing to detect a person or object in the first designated area and signaling the control circuitry to keep the solenoid energized;
when the sensor detects nothing in the first designated area, ceasing signaling the control circuitry;
the control circuitry signaling the light emitter to flash the light for a set period;
if the sensor again detects a person or object in the first designated area, the sensor signaling the control circuitry, and the control circuitry signaling the electromechanical door holder to keep the solenoid energized and signaling the light emitter to produce constant light; and
if the sensor detects nothing in the first designated area by the end of the set period, the control circuitry signaling the light emitter to turn off the light and signaling the electromechanical door holder to initiate closing of the door.
